(19) United States
(12) Patent Application Publication
(10) Pub. No.: US 2024/0386327 A1
(43) Pub. Date: Nov. 21, 2024

(54) Method, System, and Computer Program Product for Embedding Learning to Provide Uniformity and Orthogonality of Embeddings

(71) Applicant: Visa International Service Association, San Francisco, CA (US)

(72) Inventors: Yan Zheng, Los Gatos, CA (US); Prince Osei Aboagye, Salt Lake City, UT (US); Michael Yeh, Newark, CA (US); Junpeng Wang, Santa Clara, CA (US); Huiyuan Chen, San Jose, CA (US); Xin Dai, Fremont, CA (US); Liang Wang, San Jose, CA (US); Wei Zhang, Fremont, CA (US)

(21) Appl. No.: 18/667,221

(22) Filed: May 17, 2024

Related U.S. Application Data
(60) Provisional application No. 63/467,072, filed on May 17, 2023.

(51) Int. Cl. G06N 20/00

(52) U.S. Cl. CPC G06N 20/00

(57) ABSTRACT

Methods, systems, and computer program products are provided for embedding learning to provide uniformity and orthogonality of embeddings. A method may include receiving a dataset that includes a plurality of data points including a first plurality of data points having a first classification and a second plurality of data points having a second classification, generating a first normalized class mean vector of the first plurality of data instances having the first classification, generating a second normalized class mean vector of the second plurality of data instances having the second classification, performing a class rectification operation on the first plurality of data instances having the first classification and the second plurality of data instances having a second classification, and generating embeddings of the dataset based on original embedding space projections of the dataset.

### CROSS REFERENCE TO RELATED APPLICATION

This application claims priority to U.S. Provisional Patent Application No. 63/467,072 filed on May 17, 2023, the disclosure of which is incorporated by reference herein in its entirety.

### BACKGROUND

### 1. Technical Field

The present disclosure relates generally to embeddings used in machine learning models that perform classification tasks and, in some non-limiting embodiments, to methods, systems, and computer program products for embedding learning to provide uniformity and orthogonality of embeddings.

### 2. Technical Considerations

Machine learning is a field of computer science that may use statistical techniques to provide a computer system with the ability to learn (e.g., to progressively improve performance of) a task with data without the computer system being explicitly programmed to perform the task. In some instances, machine learning models may be developed for sets of data so that the machine learning models can perform a task (e.g., a task associated with a prediction) with regard to the set of data.

In some instances, a machine learning model, such as a predictive machine learning model, may be used to make a prediction regarding a risk or an opportunity based on data. A predictive machine learning model may be used to analyze a relationship between the performance of a unit based on data associated with the unit and one or more known features of the unit. The objective of the predictive machine learning model may be to assess the likelihood that a similar unit will exhibit the performance of the unit. A predictive machine learning model may be used as a fraud detection model. For example, predictive machine learning models may perform calculations based on data associated with payment transactions to evaluate the risk or opportunity of a payment transaction involving a customer, in order to guide a decision of whether to authorize the payment transaction.

An embedding (e.g., a neural embedding) may refer to a relatively low-dimensional space into which high-dimensional vectors can be translated. In some examples, the embedding may include a vector that has values which represent relationships of semantics of inputs by placing semantically similar inputs closer together in an embedding space. In some instances, embeddings may improve the performance of machine learning techniques on large inputs, such as sparse vectors representing words. For example, embeddings may be learned and reused across machine learning models.

In some instances, embeddings may be used to learn information from a database. However, in some instances, operations may need to be performed before embeddings may be used to learn the information from the database. For example, a pseudo-document and/or a graph may be required to be generated on top of the database before an embedding can be used to learn information from the database. Additionally, unless an embedding has a uniform distribution, information may not be preserved by the embedding. Furthermore, where an embedding of a class lacks orthogonality between other embeddings of other classes, features of the class may not have as high of a projection score on a vector for a similar class as the class of the embedding as compared to dissimilar classes.

### SUMMARY

Accordingly, provided are improved methods, systems, and computer program products for embedding learning to provide uniformity and orthogonality of embeddings.

According to non-limiting embodiments or aspects, provided is a computer implemented method for embedding learning to provide uniformity and orthogonality of embeddings that includes receiving a dataset comprising a plurality of data points including a first plurality of data points having a first classification and a second plurality of data points having a second classification; generating a first normalized class mean vector of the first plurality of data points having the first classification; generating a second normalized class mean vector of the second plurality of data points having the second classification; performing a class rectification operation on the first plurality of data points having the first classification and the second plurality of data points having the second classification, wherein performing the class rectification operation comprises: determining an orthogonal space between the first normalized class mean vector and the second normalized class mean vector; rotating each data point of the first plurality of data points and second plurality of data points into the orthogonal space to provide rotated data points; and projecting the rotated data points into an original embedding space of the dataset to provide original embedding space projections of the dataset; and generating embeddings of the dataset based on original embedding space projections of the dataset.

In some non-limiting embodiments or aspects, determining the orthogonal space between the first normalized class mean vector and the second normalized class mean vector includes finding a portion of the second normalized class mean vector that is orthogonal to the first normalized class mean vector; and defining a projection function to provide the orthogonal space based on the first normalized class mean vector and the portion of the second normalized class mean vector that is orthogonal to the first normalized class mean vector.

In some non-limiting embodiments or aspects, finding the portion of the second normalized class mean vector that is orthogonal to the first normalized class mean vector includes determining an inner product of the first normalized class mean vector and the second normalized class mean vector; multiplying the inner product by the first normalized class mean vector to provide a first vector product; and subtracting the first vector product from the second normalized class mean vector to provide the portion of the second normalized class mean vector that is orthogonal to the first normalized class mean vector.

In some non-limiting embodiments, rotating each data point into the orthogonal space includes rotating each data point based on the projection function to provide rotated data points.

In some non-limiting embodiments or aspects, the dataset includes a plurality of subsets of data points having a plurality of classifications, wherein each subset of data points has a respective classification, and wherein the plurality of subsets of data points includes the first plurality of data points having the first classification and the second plurality of data points having the second classification, the method may further include determining an amount of orthogonality between each subset of data points having a classification; and determining that the first plurality of data points having the first classification and the second plurality of data points having the second classification have a highest amount of orthogonality of the plurality of subsets of data points having the plurality of classifications; and wherein performing the class rectification operation comprises: performing the class rectification operation on the first plurality of data points having the first classification and the second plurality of data points having the second classification based on determining that the first plurality of data points having the first classification and the second plurality of data points having the second classification have the highest amount of orthogonality.

In some non-limiting embodiments or aspects, the method may further include determining that a third plurality of data points having a third classification and a fourth plurality of data points having a fourth classification have a second highest amount of orthogonality of the plurality of subsets of data points having the plurality of classifications; and performing the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

In some non-limiting embodiments or aspects, the method may further include generating a third normalized class mean vector of the third plurality of data points having the third classification; and generating a fourth normalized class mean vector of the fourth plurality of data points having the fourth classification; wherein performing the classrectification operation on the third plurality of data points having the third classification and the fourth plurality of data points having the fourth classification includes determining a second orthogonal space between the third normalized class mean vector and the fourth normalized class mean vector; rotating each data point of the plurality of data points into the second orthogonal space to provide second rotated data points; and projecting the second rotated data points into the original embedding space of the dataset to provide second original embedding space projections of the dataset; and wherein generating embeddings of the dataset includes generating embeddings of the dataset based on the second original embedding space projections of the dataset. According to non-limiting embodiments or aspects, provided is a system for embedding learning to provide uniformity and orthogonality of embeddings, that includes at least one processor configured to: receive a dataset comprising a plurality of data points including a first plurality of data points having a first classification and a second plurality of data points having a second classification; generate a first normalized class mean vector of the first plurality of data points having the first classification; generate a second normalized class mean vector of the second plurality of data points having the second classification; perform a class rectification operation on the first plurality of data points having the first classification and the second plurality of data points having the second classification, wherein, when performing the class rectification operation, the at least one processor is configured to: determine an orthogonal space between the first normalized class mean vector and the second normalized class mean vector; rotate each data point of the plurality of data points into the orthogonal space to provide rotated data points; and project the rotated data points into an original embedding space of the dataset to provide original embedding space projections of the dataset; and generate embeddings of the dataset based on original embedding space projections of the dataset.

In some non-limiting embodiments or aspects, when determining the orthogonal space between the first normalized class mean vector and the second normalized class mean vector, the at least one processor is configured to find a portion of the second normalized class mean vector that is orthogonal to the first normalized class mean vector; and define a projection function to provide the orthogonal space based on the first normalized class mean vector and the portion of the second normalized class mean vector that is orthogonal to the first normalized class mean vector.

In some non-limiting embodiments or aspects, when finding the portion of the second normalized class mean vector that is orthogonal to the first normalized class mean vector, the at least one processor is configured to determine an inner product of the first normalized class mean vector and the second normalized class mean vector; multiply the inner product by the first normalized class mean vector to provide a first vector product; and subtract the first vector product from the second normalized class mean vector to provide the portion of the second normalized class mean vector that is orthogonal to the first normalized class mean vector.

In some non-limiting embodiments or aspects, when rotating each data point into the orthogonal space, the at least one processor is configured to rotate each data point based on the projection function to provide rotated data points.

In some non-limiting embodiments or aspects, the dataset may include a plurality of subsets of data points having a plurality of classifications, wherein each subset of data points has a respective classification, and wherein the plurality of subsets of data points comprises the first plurality of data points having the first classification and the second plurality of data points having the second classification, and the at least one processor may be further configured to determine an amount of orthogonality between each subset of data points having a classification; and determine that the first plurality of data points having the first classification and the second plurality of data points having the second classification have a highest amount of orthogonality of the plurality of subsets of data points having the plurality of classifications; and wherein, when performing the class rectification operation, the at least one processor is configured to perform the class rectification operation on the first plurality of data points having the first classification and the second plurality of data points having the second classification based on determining that the first plurality of data points having the first classification and the second plurality of data points having the second classification have the highest amount of orthogonality.

In some non-limiting embodiments or aspects, the at least one processor may be further configured to determine that a third plurality of data points having a third classification and a fourth plurality of data points having a fourth classification have a second highest amount of orthogonality of the plurality of subsets of data points having the plurality of classifications; and perform the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

In some non-limiting embodiments or aspects, the at least one processor may be further configured to generate a third normalized class mean vector of the third plurality of data points having the third classification; and generate a fourth normalized class mean vector of the fourth plurality of data points having the fourth classification; wherein, when performing the class rectification operation on the third plurality of data points having the third classification and the fourth plurality of data points having the fourth classification, the at least one processor is configured to: determine a second orthogonal space between the third normalized class mean vector and the fourth normalized class mean vector; rotate each data point of the plurality of data points into the second orthogonal space to provide second rotated data points; and project the second rotated data points into the original embedding space of the dataset to provide second original embedding space projections of the dataset; and wherein, when generating embeddings of the dataset, the at least one processor is configured to: generate embeddings of the dataset based on the second original embedding space projections of the dataset.

According to non-limiting embodiments or aspects, provided is a computer program product for embedding learning to provide uniformity and orthogonality of embeddings, that includes at least one non-transitory computer-readable medium including program instructions that, when executed by at least one processor, cause the at least one processor to receive a dataset comprising a plurality of data points including a first plurality of data points having a first classification and a second plurality of data points having a second classification; generate a first normalized class mean vector of the first plurality of data points having the first classification; generate a second normalized class mean vector of the second plurality of data points having the second classification; perform a class rectification operation on the first plurality of data points having the first classification and the second plurality of data points having the second classification, wherein, the program instructions that cause the at least one processor to perform the class rectification operation, the at least one processor is configured to: determine an orthogonal space between the first normalized class mean vector and the second normalized class mean vector; rotate each data point of the plurality of data points into the orthogonal space to provide rotated data points; and project the rotated data points into an original embedding space of the dataset to provide original embedding space projections of the dataset; and generate embeddings of the dataset based on original embedding space projections of the dataset.

In some non-limiting embodiments or aspects, the program instructions that cause the at least one processor to determine the orthogonal space between the first normalized class mean vector and the second normalized class mean vector, may cause the at least one processor to find a portion of the second normalized class mean vector that is orthogonal to the first normalized class mean vector; and define a projection function to provide the orthogonal space based on the first normalized class mean vector and the portion of the second normalized class mean vector that is orthogonal to the first normalized class mean vector.

In some non-limiting embodiments or aspects, the program instructions that cause the at least one processor to find the portion of the second normalized class mean vector that is orthogonal to the first normalized class mean vector, may cause the at least one processor to determine an inner product of the first normalized class mean vector and the second normalized class mean vector; multiply the inner product by the first normalized class mean vector to provide a first vector product; and subtract the first vector product from the second normalized class mean vector to provide the portion of the second normalized class mean vector that is orthogonal to the first normalized class mean vector.

In some non-limiting embodiments or aspects, the program instructions that cause the at least one processor to rotate each data point into the orthogonal space, may cause the at least one processor to: rotate each data point based on the projection function to provide the rotated data points.

In some non-limiting embodiments or aspects, the dataset includes a plurality of subsets of data points having a plurality of classifications, wherein each subset of data points has a respective classification, and wherein the plurality of subsets of data points comprises the first plurality of data points having the first classification and the second plurality of data points having the second classification, wherein the program instructions may further cause the at least one processor to determine an amount of orthogonality between each subset of data points having a classification; and determine that the first plurality of data points having the first classification and the second plurality of data points having the second classification have a highest amount of orthogonality of the plurality of subsets of data points having the plurality of classifications; and wherein, the program instructions that cause the at least one processor to perform the class rectification operation, may cause the at least one processor to perform the class rectification operation on the first plurality of data points having the first classification and the second plurality of data points having the second classification based on determining that the first plurality of data points having the first classification and the second plurality of data points having the second classification have the highest amount of orthogonality.

In some non-limiting embodiments or aspects, the program instructions may further cause the at least one processor to determine that a third plurality of data points having a third classification and a fourth plurality of data points having a fourth classification have a second highest amount of orthogonality of the plurality of subsets of data points having the plurality of classifications; and perform the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

In some non-limiting embodiments or aspects, the program instructions may further cause the at least one processor to: generate a third normalized class mean vector of the third plurality of data points having the third classification; and generate a fourth normalized class mean vector of the fourth plurality of data points having the fourth classification; wherein, the program instructions that cause the at least one processor to perform the class rectification operation on the third plurality of data points having the third classification and the fourth plurality of data points having the fourth classification, cause the at least one processor to: determine a second orthogonal space between the third normalized class mean vector and the fourth normalized class mean vector; rotate each data point of the plurality of data points into the second orthogonal space to provide second rotated data points; and project the second rotated data points into the original embedding space of the dataset to provide second original embedding space projections of the dataset; and wherein, the program instructions that cause the at least one processor to generating embeddings of the dataset, cause the at least one processor to: generate embeddings of the dataset based on the second original embedding space projections of the dataset.

Further non-limiting embodiments or aspects will be set forth in the following numbered clauses:

Clause 1: A computer-implemented method, comprising: receiving, with at least one processor, a dataset comprising a plurality of data points including a first plurality of data points having a first classification and a second plurality of data points having a second classification; generating a first normalized class mean vector of the first plurality of data points having the first classification; generating a second normalized class mean vector of the second plurality of data points having the second classification; performing a class rectification operation on the first plurality of data points having the first classification and the second plurality of data points having the second classification, wherein performing the class rectification operation comprises: determining an orthogonal space between the first normalized class mean vector and the second normalized class mean vector; rotating each data point of the first plurality of data points and second plurality of data points into the orthogonal space to provide rotated data points; and projecting the rotated data points into an original embedding space of the dataset to provide original embedding space projections of the dataset; and generating embeddings of the dataset based on original embedding space projections of the dataset.

Clause 2: The computer-implemented method of clause 1, wherein determining the orthogonal space between the first normalized class mean vector and the second normalized class mean vector comprises: finding a portion of the second normalized class mean vector that is orthogonal to the first normalized class mean vector; and defining a projection function to provide the orthogonal space based on the first normalized class mean vector and the portion of the second normalized class mean vector that is orthogonal to the first normalized class mean vector.

Clause 3: The computer-implemented method of clause 1 or 2, wherein finding the portion of the second normalized class mean vector that is orthogonal to the first normalized class mean vector comprises: determining an inner product of the first normalized class mean vector and the second normalized class mean vector; multiplying the inner product by the first normalized class mean vector to provide a first vector product; and subtracting the first vector product from the second normalized class mean vector to provide the portion of the second normalized class mean vector that is orthogonal to the first normalized class mean vector.

Clause 4: The computer-implemented method of any of clauses 1-3, wherein rotating each data point into the orthogonal space comprises: rotating each data point based on the projection function to provide rotated data points.

Clause 5: The computer-implemented method of any of clauses 1-4, wherein the dataset comprises a plurality of subsets of data points having a plurality of classifications, wherein each subset of data points has a respective classification, and wherein the plurality of subsets of data points comprises the first plurality of data points having the first classification and the second plurality of data points having the second classification, the method further comprising: determining an amount of orthogonality between each subset of data points having a classification; and determining that the first plurality of data points having the first classification and the second plurality of data points having the second classification have a highest amount of orthogonality of the plurality of subsets of data points having the plurality of classifications; and wherein performing the class rectification operation comprises: performing the class rectification operation on the first plurality of data points having the first classification and the second plurality of data points having the second classification based on determining that the first plurality of data points having the first classification and the second plurality of data points having the second classification have the highest amount of orthogonality.

Clause 6: The computer-implemented method of any of clauses 1-5, further comprising: determining that a third plurality of data points having a third classification and a fourth plurality of data points having a fourth classification have a second highest amount of orthogonality of the plurality of subsets of data points having the plurality of classifications; and performing the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

Clause 7: The computer-implemented method of any of clauses 1-6, further comprising: generating a third normalized class mean vector of the third plurality of data points having the third classification; and generating a fourth normalized class mean vector of the fourth plurality of data points having the fourth classification; wherein performing the class rectification operation on the third plurality of data points having the third classification and the fourth plurality of data points having the fourth classification comprises: determining a second orthogonal space between the third normalized class mean vector and the fourth normalized class mean vector; rotating each data point of the plurality of data points into the second orthogonal space to provide second rotated data points; and projecting the second rotated data points into the original embedding space of the dataset to provide second original embedding space projections of the dataset; and wherein generating embeddings of the dataset comprises: generating embeddings of the dataset based on the second original embedding space projections of the dataset. Clause 8: A system, comprising: at least one processor configured to: receive a dataset comprising a plurality of data points including a first plurality of data points having a first classification and a second plurality of data points having a second classification; generate a first normalized class mean vector of the first plurality of data points having the first classification; generate a second normalized class mean vector of the second plurality of data points having the second classification; perform a class rectification operation on the first plurality of data points having the first classification and the second plurality of data points having the second classification, wherein, when performing the class rectification operation, the at least one processor is configured to: determine an orthogonal space between the first normalized class mean vector and the second normalized class mean vector; rotate each data point of the plurality of data points into the orthogonal space to provide rotated data points; and project the rotated data points into an original embedding space of the dataset to provide original embedding space projections of the dataset; and generate embeddings of the dataset based on original embedding space projections of the dataset.

Clause 9: The system of clause 8, wherein, when determining the orthogonal space between the first normalized class mean vector and the second normalized class mean vector, the at least one processor is configured to: find a portion of the second normalized class mean vector that is orthogonal to the first normalized class mean vector; and define a projection function to provide the orthogonal space based on the first normalized class mean vector and the portion of the second normalized class mean vector that is orthogonal to the first normalized class mean vector.

Clause 10: The system of clause 8 or 9, wherein, when finding the portion of the second normalized class mean vector that is orthogonal to the first normalized class mean vector, the at least one processor is configured to: determine an inner product of the first normalized class mean vector and the second normalized class mean vector; multiply the inner product by the first normalized class mean vector to provide a first vector product; and subtract the first vector product from the second normalized class mean vector to provide the portion of the second normalized class mean vector that is orthogonal to the first normalized class mean vector.

Clause 11: The system of any of clauses 8-10, wherein, when rotating each data point into the orthogonal space, the at least one processor is configured to: rotate each data point based on the projection function to provide rotated data points.

Clause 12: The system of any of clauses 8-11, wherein the dataset comprises a plurality of subsets of data points having a plurality of classifications, wherein each subset of data points has a respective classification, and wherein the plurality of subsets of data points comprises the first plurality of data points having the first classification and the second plurality of data points having the second classification, wherein the at least one processor is further configured to: determine an amount of orthogonality between each subset of data points having a classification; and determine that the first plurality of data points having the first classification and the second plurality of data points having the second classification have a highest amount of orthogonality of the plurality of subsets of data points having the plurality of classifications; and wherein, when performing the class rectification operation, the at least one processor is configured to: perform the class rectification operation on the first plurality of data points having the first classification and the second plurality of data points having the second classification based on determining that the first plurality of data points having the first classification and the second plurality of data points having the second classification have the highest amount of orthogonality.

Clause 13: The system of any of clauses 8-12, wherein the at least one processor is further configured to: determine that a third plurality of data points having a third classification and a fourth plurality of data points having a fourth classification have a second highest amount of orthogonality of the plurality of subsets of data points having the plurality of classifications; and perform the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

Clause 14: The system of any of clauses 8-13, wherein the at least one processor is further configured to: generate a third normalized class mean vector of the third plurality of data points having the third classification; and generate a fourth normalized class mean vector of the fourth plurality of data points having the fourth classification; wherein, when performing the class rectification operation on the third plurality of data points having the third classification and the fourth plurality of data points having the fourth classification, the at least one processor is configured to: determine a second orthogonal space between the third normalized class mean vector and the fourth normalized class mean vector; rotate each data point of the plurality of data points into the second orthogonal space to provide second rotated data points; and project the second rotated data points into the original embedding space of the dataset to provide second original embedding space projections of the dataset; and wherein, when generating embeddings of the dataset, the at least one processor is configured to: generate embeddings of the dataset based on the second original embedding space projections of the dataset.

Clause 15: A computer program product comprising at least one non-transitory computer-readable medium including program instructions that, when executed by at least one processor, cause the at least one processor to: receive a dataset comprising a plurality of data points including a first plurality of data points having a first classification and a second plurality of data points having a second classification; generate a first normalized class mean vector of the first plurality of data points having the first classification; generate a second normalized class mean vector of the second plurality of data points having the second classification; perform a class rectification operation on the first plurality of data points having the first classification and the second plurality of data points having the second classification, wherein, the program instructions that cause the at least one processor to perform the class rectification operation, the at least one processor is configured to: determine an orthogonal space between the first normalized class mean vector and the second normalized class mean vector; rotate each data point of the plurality of data points into the orthogonal space to provide rotated data points; and project the rotated data points into an original embedding space of the dataset to provide original embedding space projections of the dataset; and generate embeddings of the dataset based on original embedding space projections of the dataset.

Clause 16: The computer program product of clause 15, wherein, the program instructions that cause the at least one processor to determine the orthogonal space between the first normalized class mean vector and the second normalized class mean vector, cause the at least one processor to: find a portion of the second normalized class mean vector that is orthogonal to the first normalized class mean vector; and define a projection function to provide the orthogonal space based on the first normalized class mean vector and the portion of the second normalized class mean vector that is orthogonal to the first normalized class mean vector.

Clause 17: The computer program product of clause 15 or 16, wherein, the program instructions that cause the at least one processor to find the portion of the second normalized class mean vector that is orthogonal to the first normalized class mean vector, cause the at least one processor to: determine an inner product of the first normalized class mean vector and the second normalized class mean vector; multiply the inner product by the first normalized class mean vector to provide a first vector product; and subtract the first vector product from the second normalized class mean vector to provide the portion of the second normalized class mean vector that is orthogonal to the first normalized class mean vector.

Clause 18: The computer program product of any of clauses 15-17, wherein, the program instructions that cause the at least one processor to rotate each data point into the orthogonal space, cause the at least one processor to: rotate each data point based on the projection function to provide the rotated data points.

Clause 19: The computer program product of any of clauses 15-18, wherein the dataset comprises a plurality of subsets of data points having a plurality of classifications, wherein each subset of data points has a respective classification, and wherein the plurality of subsets of data points comprises the first plurality of data points having the first classification and the second plurality of data points having the second classification, wherein the program instructions further cause the at least one processor to: determine an amount of orthogonality between each subset of data points having a classification; and determine that the first plurality of data points having the first classification and the second plurality of data points having the second classification have a highest amount of orthogonality of the plurality of subsets of data points having the plurality of classifications; and wherein, the program instructions that cause the at least one processor to perform the class rectification operation, cause the at least one processor to: perform the class rectification operation on the first plurality of data points having the first classification and the second plurality of data points having the second classification based on determining that the first plurality of data points having the first classification and the second plurality of data points having the second classification have the highest amount of orthogonality.

Clause 20: The computer program product of any of clauses 15-19, wherein the program instructions further cause the at least one processor to: determine that a third plurality of data points having a third classification and a fourth plurality of data points having a fourth classification have a second highest amount of orthogonality of the plurality of subsets of data points having the plurality of classifications; and perform the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

Clause 21: The system of any of clauses 15-20, wherein the program instructions further cause the at least one processor to: generate a third normalized class mean vector of the third plurality of data points having the third classification; and generate a fourth normalized class mean vector of the fourth plurality of data points having the fourth classification; wherein, the program instructions that cause the at least one processor to perform the class rectification operation on the third plurality of data points having the third classification and the fourth plurality of data points having the fourth classification, cause the at least one processor to: determine a second orthogonal space between the third normalized class mean vector and the fourth normalized class mean vector; rotate each data point of the plurality of data points into the second orthogonal space to provide second rotated data points; and project the second rotated data points into the original embedding space of the dataset to provide second original embedding space projections of the dataset; and wherein, the program instructions that cause the at least one processor to generating embeddings of the dataset, cause the at least one processor to: generate embeddings of the dataset based on the second original embedding space projections of the dataset.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the present disclosure are explained in greater detail below with reference to the exemplary embodiments that are illustrated in the accompanying figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a flowchart of a non-limiting embodiment or aspect of a process for embedding learning to provide uniformity and orthogonality of embeddings;

FIGS. 3A-3C are schematic diagrams of an exemplary implementation of a system and/or method for embedding learning to provide uniformity and orthogonality of embeddings, according to some non-limiting embodiments or aspects;

FIG. 4 is a diagram of an exemplary environment in which systems, methods, and/or computer program products, described herein, may be implemented, according to some non-limiting embodiments or aspects; and

FIG. 5 is a schematic diagram of example components of one or more devices of FIG. 1 and/or FIG. 4, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device (e.g., a payment card, such as a credit or debit card), a gift card, a smartcard, smart media, a payroll card, a healthcare card, a wristband, a machine-readable medium containing account information, a keychain device or fob, a radio frequency identification (RFID) transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, RFID receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the present disclosure are directed to systems, methods, and computer program products for embedding learning to provide uniformity and orthogonality of embeddings. In some non-limiting embodiments or aspects, an embedding management system may include at least one processor configured to receive a dataset comprising a plurality of data points including a first plurality of data points of a first class and a second plurality of data points of a second class, apply a normalization procedure (e.g., a spectral normalization procedure) to the dataset to provide a normalized dataset, apply an orthogonalization procedure to the first normalized class mean vector and the second normalized class mean vector to provide a orthogonalized and normalized dataset and generate one or more embeddings based on the orthogonalized and normalized dataset.

In some non-limiting embodiments or aspects, when performing the class rectification operation, the embedding management system may determine an orthogonal space between the first normalized class mean vector and the second normalized class mean vector, rotate each data instance of the plurality of data instances into the orthogonal space to provide rotated data instances, and project the rotated data instances into an original embedding space of the dataset to provide original embedding space projections of the dataset.

In some non-limiting embodiments or aspects, when determining the orthogonal space between the first normalized class mean vector and the second normalized class mean vector, the embedding management system may find a portion of the second normalized class mean vector that is orthogonal to the first normalized class mean vector and define a projection function to provide the orthogonal space based on the first normalized class mean vector and the portion of the second normalized class mean vector that is orthogonal to the first normalized class mean vector. In some non-limiting embodiments or aspects, when finding the portion of the second normalized class mean vector that is orthogonal to the first normalized class mean vector, the embedding management system may determine an inner product of the first normalized class mean vector and the second normalized class mean vector, multiply the inner product by the first normalized class mean vector to provide a first vector product, and subtract the first vector product from the second normalized class mean vector to provide the portion of the second normalized class mean vector that is orthogonal to the first normalized class mean vector. In some non-limiting embodiments or aspects, when rotating each data instance based on the orthogonal space, the embedding management system may rotate each data instance based on the projection function to provide rotated data instances.

In some non-limiting embodiments or aspects, the dataset may include a plurality of subsets of data instances having a plurality of classifications, wherein each subset of data instances having a respective classification, wherein the plurality of subsets of data instances comprises the first plurality of data instances having the first classification and the second plurality of data instances having the second classification, and the embedding management system may determine an amount of orthogonality between each subset of data instances having a classification, determine that the first plurality of data instances having the first classification and the second plurality of data instances having the second classification have a highest amount of orthogonality of the plurality of subsets of data instances having the plurality of classifications, and when performing the class rectification operation, the embedding management system may perform the class rectification operation on the first plurality of data instances having the first classification and the second plurality of data instances having a second classification based on determining that the first plurality of data instances having the first classification and the second plurality of data instances having the second classification have the highest amount of orthogonality.

In some non-limiting embodiments or aspects, the embedding management system may determine that a third plurality of data instances having a third classification and a fourth plurality of data instances having a fourth classification have a second highest amount of orthogonality of the plurality of subsets of data instances having the plurality of classifications, and perform the class rectification operation on the third plurality of data instances having the third classification and the fourth plurality of data instances having the fourth classification based on determining that the third plurality of data instances having the third classification and the fourth plurality of data instances having the fourth classification have the second highest amount of orthogonality. In some non-limiting embodiments or aspects, the embedding management system may generate a third normalized class mean vector of the third plurality of data instances having the third classification, generate a fourth normalized class mean vector of the fourth plurality of data instances having the fourth classification, and, when performing the class rectification operation on the third plurality of data instances having the third classification and the fourth plurality of data instances having the fourth classification, the embedding management system may determine a second orthogonal space between the third normalized class mean vector and the fourth normalized class mean vector, rotate each data instance of the plurality of data instances into the second orthogonal space to provide second rotated data instances, and project the second rotated data instances into the original embedding space of the dataset to provide second original embedding space projections of the dataset, and, when generating embeddings of the dataset, the embedding management system may generate embeddings of the dataset based on the second original embedding space projections of the dataset.

In this way, the embedding management system may provide embeddings that have a more uniform distribution (e.g., on a unit hypersphere of an embedding space) and/or that are more orthogonal than embeddings that are not provided by the embedding management system. Moreover, the embedding management system may allow for a reduction in the amount of computational resources and time used to generate embeddings and improve the accuracy of embeddings. Additionally, the embedding management system may provide embeddings for generating machine learning models that provide better interpretability of results and more accurate predictions of classifications as compared to machine learning models that have not been generated using embeddings provided by the embedding management system.

For the purpose of illustration, in the following description, while the presently disclosed subject matter is described with respect to methods, systems, and computer program products for embedding learning to provide uniformity and orthogonality of embeddings, e.g., embedding learning to provide uniformity and orthogonality of embeddings for classification machine learning models, such as neural networks, which may be used in association with processing payment transactions, one skilled in the art will recognize that the disclosed subject matter is not limited to the non-limiting embodiments or aspects disclosed herein. For example, the methods, systems, and computer program products described herein may be used with a wide variety of settings and/or for making determinations (e.g., predictions, classifications, regressions, and/or the like) with at least one classification machine learning model based on a dataset, such as for fraud detection/prevention, authorization, authentication, identification, feature selection, product recommendation, and/or the like.

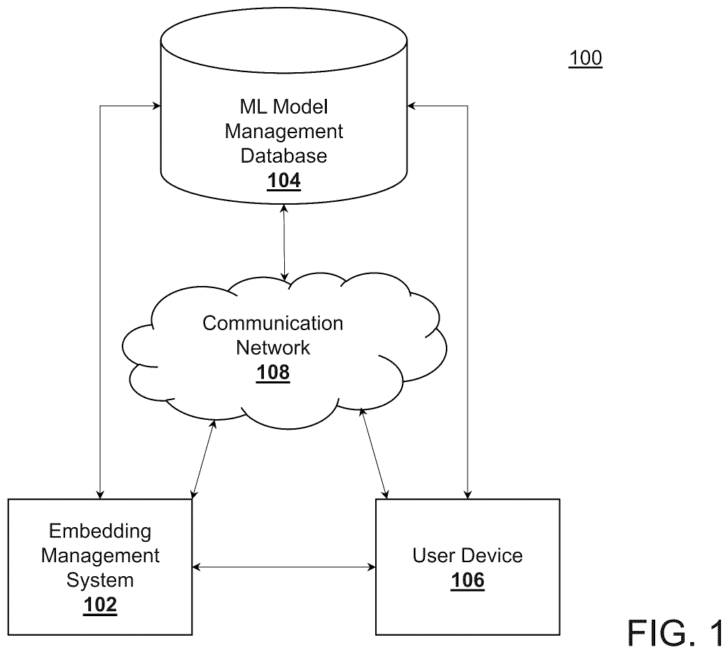

Referring now to FIG. 1, FIG. 1 is a diagram of example system 100 in which devices, systems, and/or methods, described herein, may be implemented. As shown in FIG. 1, system 100 includes embedding management system 102, machine learning (ML) model management database 104, user device 106, and communication network 108. Embedding management system 102, ML model management database 104, and/or user device 106 may interconnect (e.g., establish a connection to communicate) via wired connections, wireless connections, or a combination of wired and wireless connections.

Embedding management system 102 may include one or more devices capable of receiving information from and/or communicating information (e.g., directly via wired or wireless communication connection, indirectly via communication network 108, and/or the like) to ML model management database 104 and/or user device 106 via communication network 108. For example, embedding management system 102 may include a computing device, such as a server, a group of servers, a desktop computer, a portable computer, a mobile device, and/or other like devices. In some non-limiting embodiments or aspects, embedding management system 102 may be associated with a transaction service provider system. For example, embedding management system 102 may be operated by a transaction service provider system. In another example, embedding management system 102 may be a component of user device 106. In another example, embedding management system 102 may include ML model management database 104. In some non-limiting embodiments or aspects, embedding management system 102 may be in communication with a data storage device (e.g., ML model management database 104), which may be local or remote to embedding management system 102. In some non-limiting embodiments or aspects, embedding management system 102 may be capable of receiving information from, storing information in, transmitting information to, and/or searching information stored in the data storage device.

ML model management database 104 may include one or more devices capable of receiving information from and/or communicating information (e.g., directly via wired or wireless communication connection, indirectly via communication network 108, and/or the like) to embedding management system 102 and/or user device 106. For example, ML model management database 104 may include a computing device, such as a server, a group of servers, a desktop computer, a portable computer, a mobile device, and/or other like devices. In some non-limiting embodiments or aspects, ML model management database 104 may include a data storage device. In some non-limiting embodiments or aspects, ML model management database 104 may be capable of receiving information from, storing information in, communicating information to, or searching information stored in the data storage device. In some non-limiting embodiments or aspects, ML model management database 104 may be part of embedding management system 102 and/or part of the same system as embedding management system 102.

User device 106 may include one or more devices capable of receiving information from and/or communicating information (e.g., directly via wired or wireless communication connection, indirectly via communication network 108, and/or the like) to embedding management system 102 and/or ML model management database 104. For example, user device 106 may include a computing device, such as a mobile device, a portable computer, a desktop computer, and/or other like devices. Additionally or alternatively, user device 106 may include a device capable of receiving information from and/or communicating information to other user devices (e.g., directly via wired or wireless communication connection, indirectly via communication network 108, and/or the like). In some non-limiting embodiments or aspects, user device 106 may be part of computing management system 102 and/or part of the same system as embedding management system 102. For example, embedding management system 102, ML model management database 104, and user device 106 may all be (and/or be part of) a single system and/or a single computing device.

Communication network 108 may include one or more wired and/or wireless networks. For example, communication network 108 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

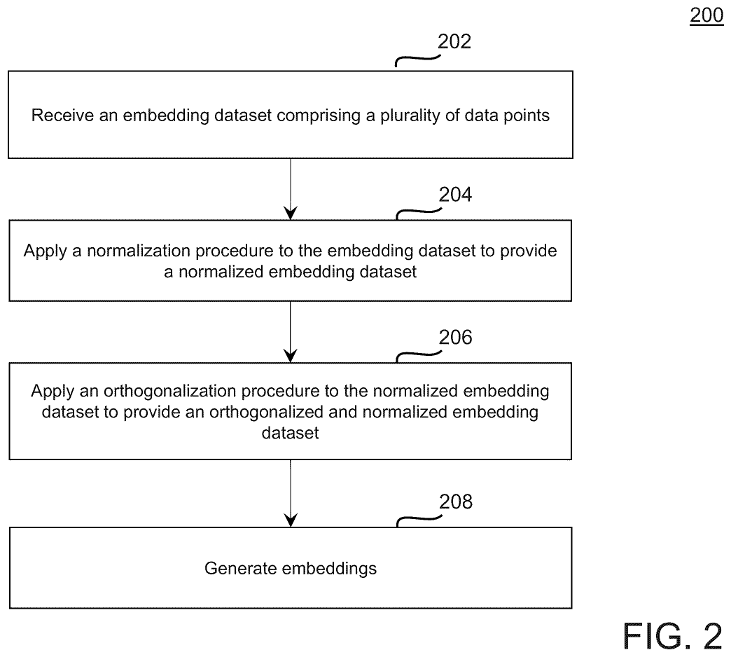

Referring now to FIG. 2, shown is a flow diagram for process 200 for embedding learning to provide uniformity and orthogonality of embeddings, according to some non-limiting embodiments or aspects. In some non-limiting embodiments or aspects, one or more of the steps of process 200 may be performed (e.g., completely, partially, etc.) by embedding management system 102 (e.g., one or more devices of embedding management system 102). In some non-limiting embodiments or aspects, one or more of the steps of process 200 may be performed (e.g., completely, partially, etc.) by another device or a group of devices separate from or including embedding management system 102 (e.g., one or more devices of embedding management system 102), ML model management database 104, and/or user device 106. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2, at step 202, process 200 includes receiving an embedding dataset comprising a plurality of data points. For example, embedding management system 102 may receive the embedding dataset (e.g., an initial training embedding dataset) that includes a plurality of data points. In some non-limiting embodiments or aspects, the dataset may include a plurality of subsets of data points having a plurality of classifications. In some non-limiting embodiments or aspects, each subset of data points has a respective classification. In some non-limiting embodiments or aspects, the dataset may include a plurality of data instances including a first plurality of data points having a first classification, a second plurality of data points having a second classification, a third plurality of data points having a third classification, a fourth plurality of data points having a fourth classification, and/or the like.

In some non-limiting embodiments or aspects, the dataset may be based on a plurality of data instances (e.g., raw data instances) associated with a plurality of features. In some non-limiting embodiments or aspects, the plurality of data instances may represent a plurality of transactions (e.g., electronic payment transactions) conducted by one or more accountholders (e.g., one or more users, such as a user associated with user device 106).

In some non-limiting embodiments or aspects, a data instance (e.g., a data instance of a dataset, such as an initial training dataset, a second training dataset, or a testing dataset) may include transaction data associated with a payment transaction. In some non-limiting embodiments or aspects, the transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a PIN, etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some examples, the dataset may be based on a large amount of data instances, such as 100 data instances, 500 data instances, 1,000 data instances, 5,000 data instances, 10,000 data instances, 25,000 data instances, 50,000 data instances, 100,000 data instances, 1,000,000 data instances, and/or the like. In some non-limiting embodiments or aspects, the plurality of data instances are labeled. In some non-limiting embodiments or aspects, the plurality of data instances are unlabeled. In some non-limiting embodiments or aspects, a percentage (e.g., a first percentage) of the plurality of data instances are labeled correctly (e.g., labeled correctly with a positive label of a binary classification, labeled correctly with a negative label of a binary classification, etc.). In some non-limiting embodiments or aspects, the plurality of data instances are labeled based on labels provided as an output of a deep learning model (e.g., a deep learning fraud detection model).

In some non-limiting embodiments or aspects, embedding management system 102 may generate the embedding dataset. In some non-limiting embodiments or aspects, embedding management system 102 may generate classifications for one or more data instances of the plurality of data instances to provide the embedding dataset. In some non-limiting embodiments or aspects, the embedding dataset may include a plurality of embeddings based on the plurality of data instances. For example, the embedding dataset may include an embedding (e.g., a feature vector) that corresponds to each data instance of the plurality of data instances. In such an example, each embedding of the embedding dataset may have a classification. In some non-limiting embodiments or aspects, the embedding dataset may include a plurality of data points (e.g., a plurality of data points that represent a plurality of features) corresponding to the plurality of embeddings. In such an example, each data point may represent one or more dimensions (e.g., one or more dimensions of a vector) of a plurality of dimensions of each embedding.

As shown in FIG. 2, at step 204, process 200 includes applying a normalization procedure to the embedding dataset to provide a normalized embedding dataset. For example, embedding management system 102 may apply a normalization procedure (e.g., a spectral normalization procedure) to the embedding dataset to provide the normalized embedding dataset. In some non-limiting embodiments or aspects, the normalized embedding dataset may include a class mean vector for each classification of the plurality of classifications included in the embedding dataset that has been normalized (e.g., normalized according to a normalization procedure).

In some non-limiting embodiments or aspects, embedding management system 102 may generate a class mean vector for each classification of a plurality of classifications. For example, for each classification of data points (e.g., data points that represent an embedding having a classification) included in an embedding dataset, embedding management system 102 may generate a class mean vector. In some non-limiting embodiments or aspects, embedding management system 102 may generate the class mean vector for a classification based on a plurality of data points associated with the classification. For example, embedding management system 102 may generate the class mean vector for the classification based on distances between the plurality of data points associated with the classification. In such an example, the class mean vector for a classification may include one or more dimensions, such that values of the one or more dimensions is equal to a value that is closest to the plurality of data points associated with the classification.

In some non-limiting embodiments or aspects, embedding management system 102 may applying the normalization procedure to the class mean vector for each classification of a plurality of classifications. For example, embedding management system 102 may applying the normalization procedure to the class mean vector for each classification so that the class mean vectors have values between [0, 1].

In some non-limiting embodiments or aspects, embedding management system 102 may determine a classification of one or more data points of a plurality of data points based on a class mean vector for the classification. For example, embedding management system 102 may provide the one or more data points an input to a classifier machine learning model (e.g., a nearest class mean classifier machine learning model) and the classifier machine learning model may provide an output. The output may include a classification for the one or more data points. In some non-limiting embodiments or aspects, embedding management system 102 may generate a cluster of data points for each classification of a plurality of classifications. For example, embedding management system 102 may generate the cluster for each classification based on determining a classification for each data point of a plurality of data points. Each cluster of data points may be associated with a classification and/or a class mean vector.

In some non-limiting embodiments or aspects, embedding management system 102 may generate a first normalized class mean vector of the first plurality of data points having the first classification and generate a second normalized class mean vector of the second plurality of data points having the second classification. In some non-limiting embodiments or aspects, embedding management system 102 may generate a third normalized class mean vector of a third plurality of data points having a third classification and/or a fourth normalized class mean vector of a fourth plurality of data points having a fourth classification.

As shown in FIG. 2, at step 206, process 200 includes applying an orthogonalization procedure to the normalized embedding dataset to provide an orthogonalized and normalized embedding dataset. For example, embedding management system 102 may apply an orthogonalization procedure to the normalized embedding dataset to provide an orthogonalized and normalized embedding dataset.

In some non-limiting embodiments or aspects, embedding management system 102 may perform a class rectification operation on a plurality of data points that have a plurality of classifications. For example, embedding management system 102 may perform a class rectification operation on a first plurality of data points having a first classification and a second plurality of data points having a second classification. In some non-limiting embodiments or aspects, when performing the class rectification operation, embedding management system 102 may apply a normalization procedure and an orthogonalization procedure. For example, steps 204 and 206 may be performed together by embedding management system 102 as a class rectification operation.

In some non-limiting embodiments or aspects, embedding management system 102 may perform the class rectification operation on the plurality of data points that have a first classification, the plurality of data points that have a second classification, the plurality of data points that have a third classification, the plurality of data points that have a fourth classification, and/or the like.

In some non-limiting embodiments or aspects, when performing the class rectification operation, embedding management system 102 may determine an orthogonal space between a first normalized class mean vector and a second normalized class mean vector, rotate each data point of a plurality of data points (e.g., a plurality of data points of an embedding dataset) that corresponds to the classifications of the first normalized class mean vector and the second normalized class mean vector into the orthogonal space to provide rotated data points, and project the rotated data points into an original embedding space of the embedding dataset to provide original embedding space projections of the dataset. In some non-limiting embodiments or aspects, embedding management system 102 may repeat the class rectification operation for pairs of normalized class means vector of an embedding dataset (e.g., a normalized embedding dataset).

In some non-limiting embodiments or aspects, when performing the class rectification operation, embedding management system 102 may determine the orthogonal space between the first normalized class mean vector and the second normalized class mean vector, project the rotated data points into an original embedding space of the embedding dataset to provide original embedding space projections of the dataset to provide projected data points, and rotate each data point of the projected data points that corresponds to the classifications of the first normalized class mean vector and the second normalized class mean vector into the orthogonal space to provide rotated data points. In some non-limiting embodiments or aspects, embedding management system 102 may repeat the class rectification operation for pairs of normalized class mean vectors of an embedding dataset (e.g., a normalized embedding dataset).

In some non-limiting embodiments or aspects, when determining the orthogonal space between the first normalized class mean vector and the second normalized class mean vector, embedding management system 102 may find a portion of the second normalized class mean vector that is orthogonal to the first normalized class mean vector and define a projection function to provide the orthogonal space based on the first normalized class mean vector and the portion of the second normalized class mean vector that is orthogonal to the first normalized class mean vector. In some non-limiting embodiments or aspects, when finding the portion of the second normalized class mean vector that is orthogonal to the first normalized class mean vector, embedding management system 102 may determine an inner product of the first normalized class mean vector and the second normalized class mean vector, multiply the inner product by the first normalized class mean vector to provide a first vector product, and subtract the first vector product from the second normalized class mean vector to provide the portion of the second normalized class mean vector that is orthogonal to the first normalized class mean vector. In some non-limiting embodiments or aspects, when rotating each data instance based on the orthogonal space, embedding management system 102 may rotate each data instance based on the projection function to provide rotated data points.

In some non-limiting embodiments or aspects, embedding management system 102 may determine an amount of orthogonality between each cluster of data points having a classification. For example, embedding management system 102 may determine an amount of orthogonality between a first cluster of data points having a first classification and a second cluster of data points having a second classification. In some non-limiting embodiments or aspects, embedding management system 102 may determine the orthogonal space between a first class mean vector and a second class mean vector based on the amount of orthogonality between the first cluster of data points (e.g., associated with the first class mean vector) having a first classification and a second cluster of data points (e.g., associated with the second class mean vector) having a second classification. In some non-limiting embodiments or aspects, embedding management system 102 may determine additional orthogonal space between pairs of class mean vectors based on the amount of orthogonality between pairs of subsets of data points having additional classifications.

In some non-limiting embodiments or aspects, embedding management system 102 may determine that the first plurality of data points having the first classification and the second plurality of data points having the second classification have the highest amount of orthogonality of the plurality of subsets of data points having the plurality of classifications. Further, embedding management system 102 may perform the class rectification operation on the first plurality of data points having the first classification and the second plurality of data points having a second classification based on determining that the first plurality of data points having the first classification and the second plurality of data points having the second classification have the highest amount of orthogonality.

In some non-limiting embodiments or aspects, embedding management system 102 may determine that a third plurality of data points having a third classification and a fourth plurality of data points having a fourth classification have a second highest amount of orthogonality of the plurality of subsets of data points having the plurality of classifications. Further, embedding management system 102 may perform the class rectification operation on the third plurality of data points having the third classification and the fourth plurality of data points having the fourth classification based on determining that the third plurality of data points having the third classification and the fourth plurality of data points having the fourth classification have the second highest amount of orthogonality. In some non-limiting embodiments or aspects, embedding management system 102 may perform the class rectification operation on additional subsets of data points having different classifications based on a ranking of an amount of orthogonality between the additional subsets of data points.

In some non-limiting embodiments or aspects, when performing the class rectification operation on the third plurality of data points having the third classification and the fourth plurality of data points having the fourth classification, embedding management system 102 may determine a second orthogonal space between the third normalized class mean vector and the fourth normalized class mean vector, rotate each data point of the plurality of data points into the second orthogonal space to provide second rotated data points, and project the second rotated data points into the original embedding space of the dataset to provide second original embedding space projections of the dataset.

In some non-limiting embodiments or aspects, a result (e.g., an orthogonalized and normalized dataset of embeddings) of the class rectification operation may include a plurality of class mean vectors that are orthogonal to each other. Additionally or alternatively, the result of the class rectification operation may include a plurality of class mean vectors that are orthogonal to each other and are also aligned with coordinate axes.

As shown in FIG. 2, at step 208, process 200 includes generating embeddings. For example, embedding management system 102 may generate one or more embeddings of an updated embedding dataset. In some non-limiting embodiments or aspects, embedding management system 102 may generate embeddings of the dataset based on the original embedding space projections of the embedding dataset. Additionally or alternatively, embedding management system 102 may generate embeddings of the dataset based on the second original embedding space projections of the embedding dataset.

In some non-limiting embodiments or aspects, embedding management system 102 may generate a machine learning model (e.g., a neural network machine learning model) based on one or more embeddings generated by applying an orthogonalization procedure and/or a normalization procedure. For example, embedding management system 102 may generate the machine learning model by including the embeddings generated by embedding management system 102 in the machine learning model. In another example, embedding management system 102 may generate a machine learning model based on one or more embeddings generated by applying a class rectification operation.

In some non-limiting embodiments or aspects, embedding management system 102 may perform an action, such as a fraud prevention procedure, a transaction authorization procedure, and/or a recommendation procedure, using the machine learning model (e.g., a trained machine learning model in an online environment). For example, embedding management system 102 may perform the action based on determining to perform the action. In some non-limiting embodiments or aspects, embedding management system 102 may perform a fraud prevention procedure associated with protection of an account of a user (e.g., a user associated with user device 106) based on an output of the machine learning model (e.g., an output that includes a prediction associated with the account of the user). For example, if the output of the machine learning model indicates that the fraud prevention procedure is necessary, embedding management system 102 may perform the fraud prevention procedure associated with protection of the account of the user. In such an example, if the output of the machine learning model indicates that the fraud prevention procedure is not necessary, embedding management system 102 may forego performing the fraud prevention procedure associated with protection of the account of the user. In some non-limiting embodiments or aspects, embedding management system 102 may execute a fraud prevention procedure based on a classification of an input as provided by the machine learning model.

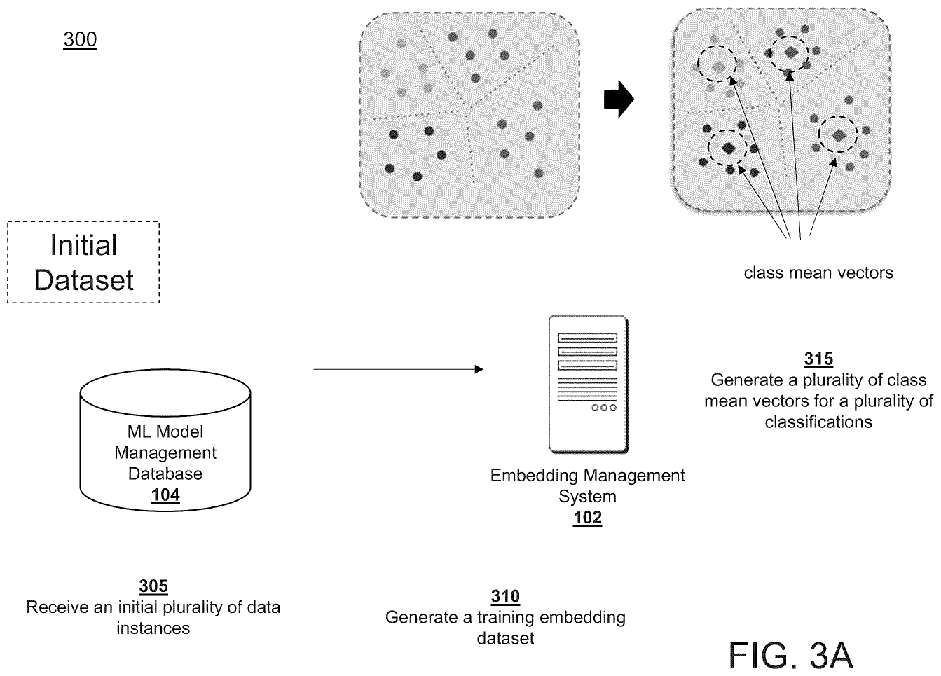

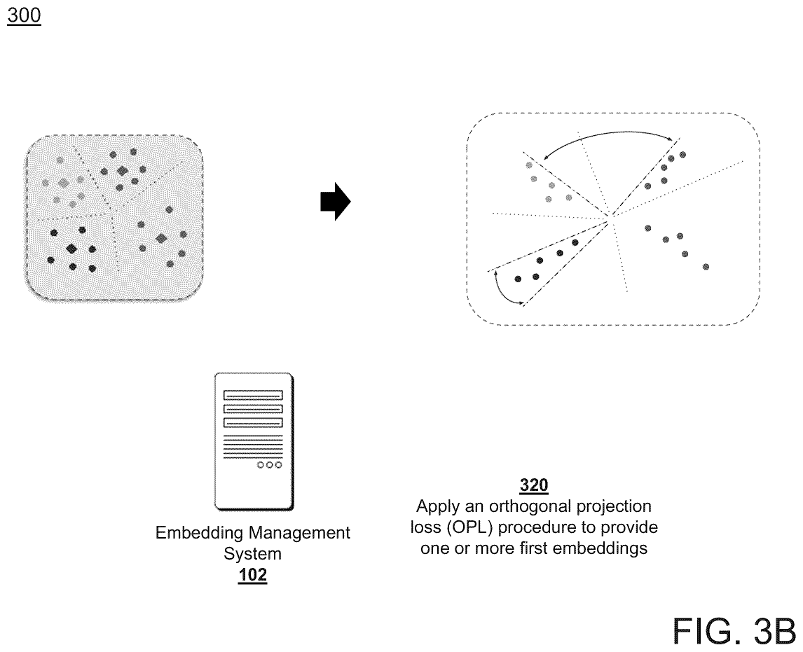

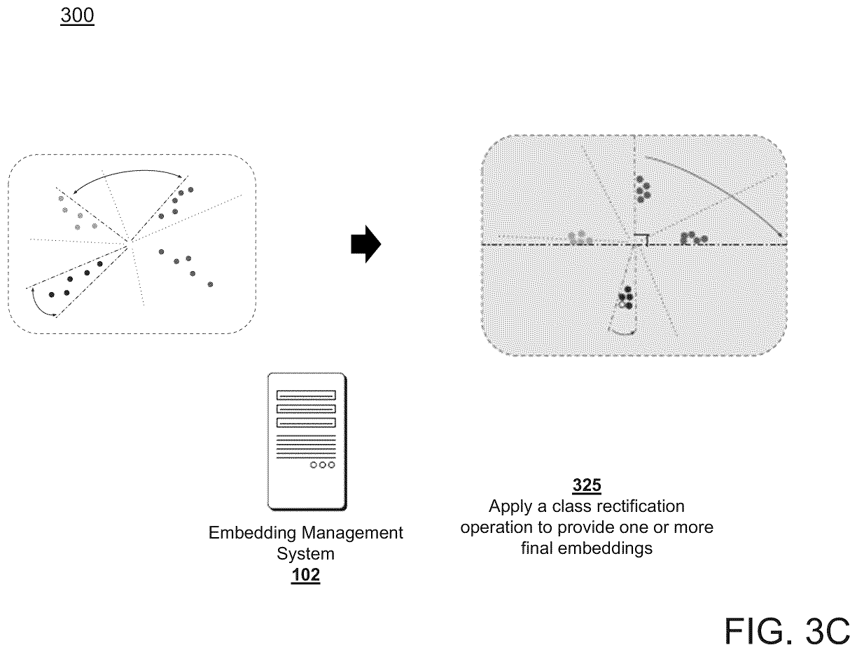

Referring now to FIGS. 3A-3C, shown are schematic diagrams of implementation 300 of a process (e.g., process 200) for embedding learning to provide uniformity and orthogonality of embeddings. In some non-limiting embodiments or aspects, one or more of the steps of the process may be performed (e.g., completely, partially, etc.) by embedding management system 102 (e.g., one or more devices of embedding management system 102). In some non-limiting embodiments or aspects, one or more of the steps of the process may be performed (e.g., completely, partially, etc.) by another device or a group of devices separate from or including embedding management system 102 (e.g., one or more devices of embedding management system 102), ML model management database 104, and/or user device 106.

As shown by reference number 305 in FIG. 3A, embedding management system 102 may receive an initial plurality of data instances. As further shown by reference number 310 in FIG. 3A, embedding management system 102 may generate a training embedding dataset based on the initial plurality of data instances.

The training embedding dataset may be represented as Z∪Z, where each zᵢ E Z is associated with a classification (e.g., a label for a classification of a plurality of classifications), and yᵢ ∈[k], where k is the number of classifications (e.g., distinct classes) included in the dataset. In some non-limiting embodiments or aspects, implementation 300 may operate in two phases, with a goal of creating a final embedding in [symbol] ^{d}, where d is a number of dimensions and with d>k. The first phase may learn an embedding, ƒ₁:Z→ [symbol] ^{d} with a goal of classifications being linearly separable in [symbol] ^{d}. The second phase provides another map, ƒ₂: [symbol] ^{d} R→ [symbol] ^{d}, which aims to provide linear separability between classes (e.g., classes of embeddings) and/or to provide orthogonality among classifications. In some non-limiting embodiments or aspects, the second phase may be interpreted as a form of learning (e.g., the second phase only involves training procedures and not testing data) and may be considered a deterministic procedure that does not follow a traditional optimization of parameters approach with regard to a loss function.

In some non-limiting embodiments or aspects, given input data (Z, y), the embedding provided after phase 1 may be represented as X′={x′=ƒ₁(zᵢ)∈ [symbol] ^{d}|zᵢ ∈Z}. The embedding provided after phase 2 may be represented as X={xᵢ=ƒ₂ (xᵢ′)∈ [symbol] ^{d}|xᵢ′∈X′}. Zⱼ, Xⱼ′, and Xⱼ may represent data points in class j∈[k] for the initial dataset, the first embedding, and the final embedding, respectively. In some non-limiting embodiments or aspects, with regard to phase 2, before an iterative class rectification (ICR) operation or a discontinuous class rectification (DCR) operation is applied to determine X, the initial embedding X′ may be learned and frozen so that it is not changed. Once X←ƒ₂ (X′) is created, then ƒ₂ may operate on X′ without adjusting ƒ₁.

In some non-limiting embodiments or aspects, embedding management system 102 may generate one or more classifier machine learning models. For example, embedding management system 102 may generate one or more classifier machine learning models based on a Roccio algorithm and/or a logistic regression. In some non-limiting embodiments or aspects, when generating the training embedding dataset, embedding management system 102 may determine a classification of each data point of the training embedding dataset using the one or more classifier machine learning models.

As further shown by reference number 315 in FIG. 3A, embedding management system 102 may generate a plurality of class mean vectors for a plurality of classifications. For example, embedding management system 102 may generate a class mean vector for each classification of the plurality of classifications of the training embedding dataset.

In some non-limiting embodiments or aspects, for an embedding dataset (X, y), embedding management system 102 may generate a class mean vector based on the formula Xⱼ′:

$${v}_{j} = \frac{1}{\vert {X}_{j} \vert} {\sum }_{{x}_{i} ∈ {X}_{j}} {x}_{i}$$

for each class, j∈[k]. For a training datapoint, x∈ [symbol] ^{d}, embedding management system 102 may predict a classification based on the formula:

[symbol]

$$\hat{j} = arg {min}_{j ∈ [ k ]} D ( x , {v}_{j} )$$

In some non-limiting embodiments or aspects, embedding management system 102 may apply a normalization procedure to the class mean vector for each classification of the plurality of classifications of the training embedding dataset to provide a normalization

In some non-limiting embodiments or aspects, embedding management system 102 may normalize all class mean vectors, so that vⱼ←vⱼ/∥vⱼ∥, when using Euclidean distance, D(x, vⱼ)=∥x−vⱼ∥, the Euclidian distance has the same ordering as cosine distance. With this, embedding management system 102 may predict a classification based on the formula:

$$\hat{j} = arg {max}_{j ∈ [ k ]} 〈 x , {v}_{j} 〉 .$$

As further shown by reference number 320 in FIG. 3B, embedding management system 102 may apply an orthogonal projection loss (OPL) procedure to provide one or more first embeddings.

In some non-limiting embodiments or aspects, embedding management system 102 may provide the first embedding (e.g., as a final output) based on three goals, including accuracy (e.g., each classification may be linearly separable from all other classifications), compactness (e.g., each classification, Xⱼ′, has data points that are close to each other, such that there is a small variance), and dispersion, for example, that each pair of classes, represented as j and j, are separated and are orthogonal (e.g., substantially orthogonal). In some non-limiting embodiments or aspects, a loss function for ƒ₁ may be represented by the formula:

$${ℒ}_{{f}_{1}} = {ℒ}_{CE} + λ ( {ℒ}_{comp} + {ℒ}_{disp} )$$

[symbol] _{CE} may represent a standard cross entropy loss that optimizes accuracy for λ ∈[0,1] and where [symbol] _{comp} and [symbol] _{disp} optimize compactness and dispersion, respectfully. These loss functions may be actualized with |Z|=n, k classes, n₁=Σ_{j∈[k]}|Zⱼ|(|Zⱼ|−1), and n₂=Σ_{j∈[k]}|Zⱼ|(n−1Z₁|) according to the following formulas:

$${ℒ}_{comp} = 1 - \frac{1}{{n}_{1}} {\sum }_{j ∈ [ k ]} {\sum }_{{z}_{i} , {z}_{{i}^{′}} ∈ {Z}_{j}} 〈 {f}_{1} ( {z}_{i} ) , {f}_{1} ( {z}_{{i}^{′}} ) 〉 , \qquad ( 1 )$$

$${ℒ}_{disp} = \vert \frac{1}{{n}_{2}} {\sum }_{{z}_{i} ∈ {Z}_{j} ; {z}_{{i}^{′}} ∈ {Z}_{{j}^{′}} \neq j} 〈 {f}_{1} ( {z}_{i} ) , {f}_{1} ( {z}_{{i}^{′}} ) 〉 \vert$$

$$or$$

$${ℒ}_{comp} = - \frac{1}{n} {\sum }_{i = 1}^{n} log \frac{exp ( 〈 {f}_{1} ( {z}_{i} ) , {v}_{{j}_{i}} ) 〉}{{\sum }_{j = 1}^{k} exp ( 〈 {f}_{1} ( {z}_{i} ) , {v}_{j} 〉 )} , \qquad ( 2 )$$

$${ℒ}_{disp} = \frac{1}{k} {\sum }_{j ∈ [ k ]} log \frac{1}{k - 1} {\sum }_{{j}^{′} \neq j} exp ( 〈 {v}_{j} , {v}_{{j}^{′}} 〉$$

The first formula represents a loss function for a machine learning model generated according to an OPL procedure. The second formula represents an alternate loss function for a machine learning model generated according to a consensus-based image description evaluation (CIDEr) procedure.

As further shown by reference number 325 in FIG. 3C, embedding management system 102 may apply a class rectification operation to provide one or more final embeddings.

With regard to the second phase of implementation 300, the second phase provides a deterministic approach that enforces orthogonality of class mean vectors. In some non-limiting embodiments or aspects, the second phase may involve performing a class rectification operation to provide a final embedding. In some non-limiting embodiments or aspects, the class rectification operation may include an ICR operation, a DCR operation, or a multiclass ICR operation. In some non-limiting embodiments or aspects, the class rectification operation may be designed to orthogonalize subspaces (e.g., embedding subspaces) to reduce bias.

In some non-limiting embodiments or aspects, with an ICR operation, embedding management system 102 may determine a pair of individual classifications (e.g., authorized or unauthorized, male or female, pleasant or unpleasant, etc.), normalize the pair of individual classifications, and apply a graded rotation operation to the pair of individual classifications that have been centered. In some non-limiting embodiments or aspects, the graded rotation operation applies a unique rotation for each data point to all points, so the embedding subspaces become more orthogonal. In some non-limiting embodiments or aspects, because data points in classifications are clustered by cosine similarity around the class mean vector for the classification, the graded rotation takes place around the origin of a Cartesian coordinate system and does not require a centering step. Furthermore, the ICR operation allows for considering two classifications at a time and applies an operation that makes the class mean vectors for the two classifications orthogonal. In some non-limiting embodiments, the ICR operation may be carried out according to the following, binary iterative classification rectification function, BinaryICR (X, X₁, X₂, and T iterations):

$$for i = 0 , 1 , … , T - 1 do$$

$${v}_{1} , {v}_{2} ← normalized means ( {X}_{1} , {X}_{2} )$$

$$BinaryCR ( X , {v}_{1} , {v}_{2} )$$

The ICR operation may be carried out according to the following, binary classification rectification function, BinaryCR(X, u, v):

$$Set {v}^{′} = v - 〈 u , v 〉 u$$

$$Define projection π ( \cdot ) = ( 〈 \cdot , u 〉 , 〈 \cdot , {v}^{′} 〉 )$$

$$for x ∈ X do$$

$$\tilde{x} ← GradedRotat ( π ( u ) , π ( v ) , π ( x ) )$$

$$x ← x + ( 〈 π ( u ) , \tilde{x} - π ( x ) 〉 u + 〈 π ( {v}^{′} ) , \tilde{x} - π ( x ) 〉 {v}^{′} )$$

As shown above, for the BinaryICR operation, for each iteration from 0 to T −1, the normalized class mean vectors, v₁ and v₂, for embedding X₁ and embedding X₂ are calculated. The normalized class mean vectors are provided as inputs, along with the embedding provided based on the first phase, to the formula for BinaryCR.

A projection function is defined as π(·)=( [symbol] , u [symbol] , [symbol] ·, v′ [symbol] ) and the projection function is provided as an input to a graded rotation function. The output of the graded rotation function may include a rotated data point that has been rotated into an orthogonal space.

The graded rotation function may be carried out according to the following, graded rotation function, GradedRotat(v₁, v₂, x):

$$Input : Unit vectors {v}_{1} , {v}_{2} in {ℝ}^{2} and x ∈ {ℝ}^{2}$$

$$Set {θ}^{′} = arc cos ( 〈 {v}_{1} , {v}_{2} 〉 ) and θ = \frac{π}{2} - {θ}^{′}$$

$$Set {ϕ}_{1} = arc cos 〈 {v}_{1} , \frac{x}{\vert x \vert} 〉$$

$$Set {v}_{2}^{′} = {v}_{2} - 〈 {v}_{1} , {v}_{2} 〉 {v}_{1}$$

$$Set {d}_{2} = arc cos 〈 {v}_{2}^{′} , \frac{x}{\vert x \vert} 〉$$

$$Compute {θ}_{x} = \{ \begin{matrix}θ \frac{{ϕ}_{1}}{{θ}^{′}} & if {d}_{2} > 0 and {ϕ}_{1} \leq {θ}^{′} \\ θ \frac{π - {ϕ}_{1}}{π - {θ}^{′}} & if {d}_{2} > 0 and {ϕ}_{1} > {θ}^{′} \\ - θ \frac{π - {ϕ}_{1}}{{θ}^{′}} & if {d}_{2} < 0 and {ϕ}_{1} \geq π - {θ}^{′} \\ - θ \frac{{ϕ}_{1}}{π - {θ}^{′}} & if {d}_{2} < 0 and {ϕ}_{1} < π - {θ}^{′}\end{matrix}$$

$$return {R}_{{θ}_{x}} x$$

$$Where : {R}_{θ} = ⌈ \begin{matrix}cos θ & - sin θ \\ sin θ & cos θ\end{matrix} ⌉$$

In some non-limiting embodiments or aspects, the multiclass ICR operation may be carried out according to the following, multiclass ICR function, (X, X₁, . . . , Xₖ, and T iterations):

```
for i = 0, 1, . . . , T − 1 do
  Let vᵢ be the normalized mean vector of class Xᵢ for i = 1, 2, . . . . k.
  Set r, s = argmin_{1≤i,j≤k} | [symbol]   vᵢ, vⱼ [symbol]   |, WLOG suppose r = 1, s = 2
  Let S₁ and S₂ be the span of {v₁} and {v₁, v₂} respectively
  Run BinaryCR(X, v₁, v₂)
  Recalculate normalized class means vᵢ for all i
  for i = 3, . . . , k do
    Choose t = argmin_{j≥i} [symbol]   v₁, vⱼ [symbol]   ² + [symbol]   v₂, vⱼ [symbol]   ² + . . . [symbol]   vᵢ₋₁, vⱼ [symbol]   ²
    WLOG assume t = i
    Let v̅ᵢ be the projection of vᵢ onto Sᵢ₋₁
    Set uᵢ = vᵢ − Σⱼ₌₁ⁱ⁻¹ [symbol]   vⱼ, vᵢ [symbol]   vⱼ and v′ᵢ = uᵢ/∥uᵢ∥
    Run BinaryCR(X, v′ᵢ, v̅ᵢ)
    Set Sᵢ to be the span of {Sᵢ₋₁, vᵢ}
    Recalculate class normalized means vⱼ for all j
```

When carrying out the multiclass ICR operation, embedding management system 102 may determine the class mean vectors that are most orthogonal and apply one step of BinaryCR function. Then at each iteration, embedding management system 102 may determine the subspace of the class mean vector of Sᵢ₋₁, and find the class mean, vᵢ, most orthogonal to that subspace. In some non-limiting embodiments or aspects, embedding management system 102 may project vᵢ onto Sᵢ₋₁, to get v̅ⱼ̅, and the run one step of BinaryICR to orthogonalize vᵢ from v̅ⱼ̅ (e.g., and to all of Sᵢ₋₁). Once all classifications have been addressed, embedding management system 102 may iterate this entire procedure a number of times (e.g., 1 or 2 iterations and no more than 5 iterations). With the multiclass ICR operation, the class means on the embeddings v₁, . . . , Vₖ are all orthogonal (e.g., up to several digits of precision). To complete the definition of function ƒ₂, a final transformation step is performed that aligns v₁, . . . , Vₖ to the k coordinate axes. In some non-limiting embodiments or aspects, this step is defined by a single orthogonal matrix, so the final transformation step does not change the Euclidean distance or the dot products between any pair of embedding data points.

In some non-limiting embodiments or aspects, the DCR operation may be carried out according to the following, binary discontinuous classification rectification function, BinaryDCR (X, X₁, X₂):

$${v}_{1} , {v}_{2} ← normalized means ( {X}_{1} , {X}_{2} )$$

$${θ}^{′} ← angle between {v}_{1} and {v}_{2} ; θ = \frac{π}{2} - {θ}^{′}$$

$$if ( {θ}^{′} \leq \frac{π}{2} ) then set angle ϕ = {θ}^{′} / 2$$

$$else set angle ϕ = \frac{π}{4}$$

$$for x ∈ \{ x ∈ X \vert 〈 {v}_{2} , x 〉 \leq ϕ \} do$$

$$x ← {R}_{θ} x$$

The DCR operation does not require iteration, at the expense of a discontinuous operation. The DCR operation replaces the graded rotation function with a set that identifies a conical region around v₂, and applies an angle ϕ to all points in this region so afterwards [symbol] v₁, v₂ [symbol] =0. If the angle between v₁ and v₂ is acute, then the conical region is defined in the span of v₁, V₂ by an angle θ from v₂ to the bisector direction between v₁ and v₂. That is, for data points closer to v₂, they are moved along with v₂, the remaining data points are left alone. If the angle between v₁ and v₂ is obtuse, then a conical angle around v₂ is π/4, and the only points that will be moved are those of that which will be closer to v₂ after the transformation when [symbol] v₁, v₂ [symbol] =0.

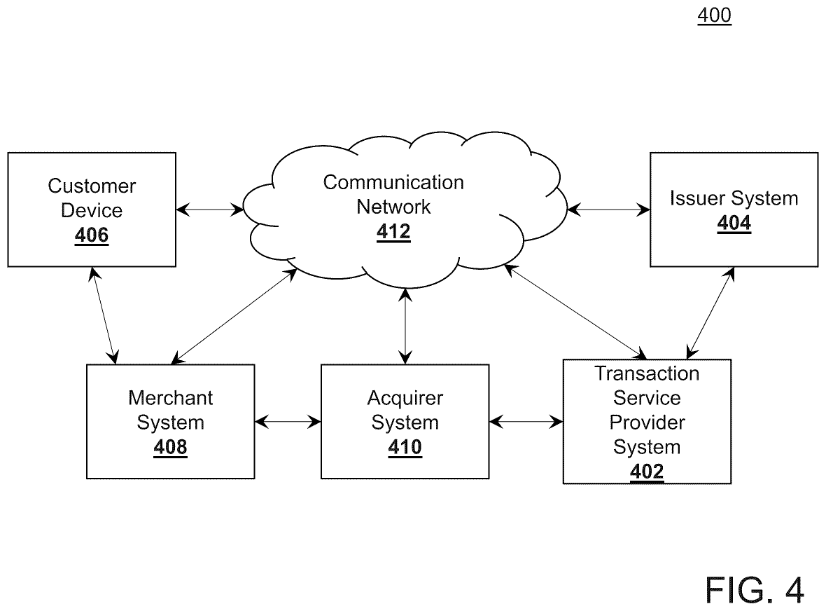

Referring now to FIG. 4, shown is a diagram of a non-limiting embodiment or aspect of exemplary environment 400 in which methods, systems, and/or products, as described herein, may be implemented. As shown in FIG. 4, environment 400 may include transaction service provider system 402, issuer system 404, customer device 406, merchant system 408, acquirer system 410, and communication network 412. In some non-limiting embodiments or aspects, each of embedding management system 102, ML model management database 104, and/or user device 106 of FIG. 1 may be implemented by (e.g., part of) transaction service provider system 402. In some non-limiting embodiments or aspects, at least one of embedding management system 102, ML model management database 104, and/or user device 106 of FIG. 1 may be implemented by (e.g., part of) another system, another device, another group of systems, or another group of devices, separate from or including transaction service provider system 402, such as issuer system 404, customer device 406, merchant system 408, acquirer system 410, and/or the like.

Transaction service provider system 402 may include one or more devices capable of receiving information from and/or communicating information to issuer system 404, customer device 406, merchant system 408, and/or acquirer system 410 via communication network 412. For example, transaction service provider system 402 may include a computing device, such as a server (e.g., a transaction processing server), a group of servers, and/or other like devices. In some non-limiting embodiments or aspects, transaction service provider system 402 may be associated with a transaction service provider, as described herein. In some non-limiting embodiments or aspects, transaction service provider system 402 may be in communication with a data storage device, which may be local or remote to transaction service provider system 402. In some non-limiting embodiments or aspects, transaction service provider system 402 may be capable of receiving information from, storing information in, communicating information to, or searching information stored in the data storage device.

Issuer system 404 may include one or more devices capable of receiving information and/or communicating information to transaction service provider system 402, customer device 406, merchant system 408, and/or acquirer system 410 via communication network 412. For example, issuer system 404 may include a computing device, such as a server, a group of servers, and/or other like devices. In some non-limiting embodiments or aspects, issuer system 404 may be associated with an issuer institution, as described herein. For example, issuer system 404 may be associated with an issuer institution that issued a credit account, debit account, credit card, debit card, and/or the like to a user associated with customer device 406.

Customer device 406 may include one or more devices capable of receiving information from and/or communicating information to transaction service provider system 402, issuer system 404, merchant system 408, and/or acquirer system 410 via communication network 412. Additionally or alternatively, each customer device 406 may include a device capable of receiving information from and/or communicating information to other customer devices 406 via communication network 412, another network (e.g., an ad hoc network, a local network, a private network, a virtual private network, and/or the like), and/or any other suitable communication technique. For example, customer device 406 may include a client device and/or the like. In some non-limiting embodiments or aspects, customer device 406 may or may not be capable of receiving information (e.g., from merchant system 408 or from another customer device 406) via a short-range wireless communication connection (e.g., an NFC communication connection, an RFID communication connection, a Bluetooth® communication connection, a Zigbee® communication connection, and/or the like), and/or communicating information (e.g., to merchant system 408) via a short-range wireless communication connection.

Merchant system 408 may include one or more devices capable of receiving information from and/or communicating information to transaction service provider system 402, issuer system 404, customer device 406, and/or acquirer system 410 via communication network 412. Merchant system 408 may also include a device capable of receiving information from customer device 406 via communication network 412, a communication connection (e.g., an NFC communication connection, an RFID communication connection, a Bluetooth® communication connection, a Zigbee® communication connection, and/or the like) with customer device 406, and/or the like, and/or communicating information to customer device 406 via communication network 412, the communication connection, and/or the like. In some non-limiting embodiments or aspects, merchant system 408 may include a computing device, such as a server, a group of servers, a client device, a group of client devices, and/or other like devices. In some non-limiting embodiments or aspects, merchant system 408 may be associated with a merchant, as described herein. In some non-limiting embodiments or aspects, merchant system 408 may include one or more client devices. For example, merchant system 408 may include a client device that allows a merchant to communicate information to transaction service provider system 402. In some non-limiting embodiments or aspects, merchant system 408 may include one or more devices, such as computers, computer systems, and/or peripheral devices capable of being used by a merchant to conduct a transaction with a user. For example, merchant system 408 may include a POS device and/or a POS system.

Acquirer system 410 may include one or more devices capable of receiving information from and/or communicating information to transaction service provider system 402, issuer system 404, customer device 406, and/or merchant system 408 via communication network 412. For example, acquirer system 410 may include a computing device, a server, a group of servers, and/or the like. In some non-limiting embodiments or aspects, acquirer system 410 may be associated with an acquirer, as described herein.

Communication network 412 may include one or more wired and/or wireless networks. For example, communication network 412 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 4 are provided as an example. There may be additional systems, devices, and/or networks; fewer systems, devices, and/or networks; different systems, devices, and/or networks; and/or differently arranged systems, devices, and/or networks than those shown in FIG. 4. Furthermore, two or more systems or devices shown in FIG. 4 may be implemented within a single system or device, or a single system or device shown in FIG. 4 may be implemented as multiple, distributed systems or devices. Additionally or alternatively, a set of systems (e.g., one or more systems) or a set of devices (e.g., one or more devices) of environment 400 may perform one or more functions described as being performed by another set of systems or another set of devices of environment 400.

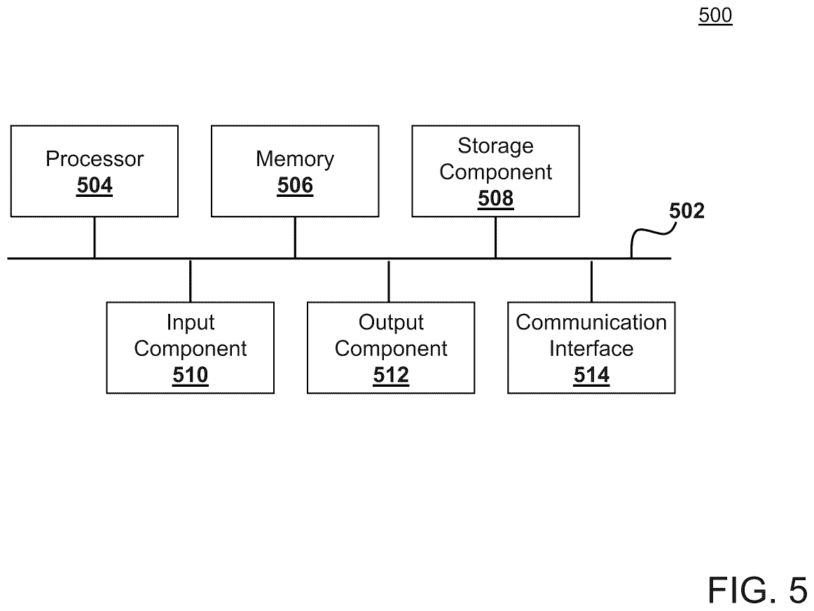

Referring now to FIG. 5, shown is a diagram of example components of device 500, according to non-limiting embodiments or aspects. Device 500 may correspond to at least one of embedding management system 102, ML model management database 104, and/or user device 106 in FIG. 1 and/or at least one of transaction service provider system 402, issuer system 404, customer device 406, merchant system 408, and/or acquirer system 410 in FIG. 4, as an example. In some non-limiting embodiments or aspects, such systems or devices in FIG. 1 or FIG. 4 may include at least one device 500 and/or at least one component of device 500. The number and arrangement of components shown in FIG. 5 are provided as an example. In some non-limiting embodiments or aspects, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments or aspects, processor 504 may be implemented in hardware, firmware, or a combination of hardware and software. For example, processor 504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 506 may include random access memory (RAM), read only memory (ROM), and/or another type of dynamic or static storage device (e.g., flash memory, magnetic memory, optical memory, etc.) that stores information and/or instructions for use by processor 504.

With continued reference to FIG. 5, storage component 508 may store information and/or software related to the operation and use of device 500. For example, storage component 508 may include a hard disk (e.g., a magnetic disk, an optical disk, a magneto-optic disk, a solid-state disk, etc.) and/or another type of computer-readable medium. Input component 510 may include a component that permits device 500 to receive information, such as via user input (e.g., a touch screen display, a keyboard, a keypad, a mouse, a button, a switch, a microphone, etc.). Additionally or alternatively, input component 510 may include a sensor for sensing information (e.g., a global positioning system (GPS) component, an accelerometer, a gyroscope, an actuator, etc.). Output component 512 may include a component that provides output information from device 500 (e.g., a display, a speaker, one or more light-emitting diodes (LEDs), etc.). Communication interface 514 may include a transceiver-like component (e.g., a transceiver, a separate receiver and transmitter, etc.) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium may include any non-transitory memory device. A memory device includes memory space located inside of a single physical storage device or memory space spread across multiple physical storage devices. Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, a dataset comprising a plurality of data points including a first plurality of data points having a first classification and a second plurality of data points having a second classification;
generating a first normalized class mean vector of the first plurality of data points having the first classification;
generating a second normalized class mean vector of the second plurality of data points having the second classification;
performing a class rectification operation on the first plurality of data points having the first classification and the second plurality of data points having the second classification, wherein performing the class rectification operation comprises:
determining an orthogonal space between the first normalized class mean vector and the second normalized class mean vector;
rotating each data point of the first plurality of data points and the second plurality of data points into the orthogonal space to provide rotated data points; and
projecting the rotated data points into an original embedding space of the dataset to provide original embedding space projections of the dataset; and
generating embeddings of the dataset based on the original embedding space projections of the dataset.

2. The computer-implemented method of claim 1, wherein determining the orthogonal space between the first normalized class mean vector and the second normalized class mean vector comprises:
finding a portion of the second normalized class mean vector that is orthogonal to the first normalized class mean vector; and
defining a projection function to provide the orthogonal space based on the first normalized class mean vector and the portion of the second normalized class mean vector that is orthogonal to the first normalized class mean vector.

3. The computer-implemented method of claim 2, wherein finding the portion of the second normalized class mean vector that is orthogonal to the first normalized class mean vector comprises:
determining an inner product of the first normalized class mean vector and the second normalized class mean vector;
multiplying the inner product by the first normalized class mean vector to provide a first vector product; and
subtracting the first vector product from the second normalized class mean vector to provide the portion of the second normalized class mean vector that is orthogonal to the first normalized class mean vector.

4. The computer-implemented method of claim 2, wherein rotating each data point into the orthogonal space comprises:
rotating each data point based on the projection function to provide the rotated data points.

5. The computer-implemented method of claim 1, wherein the dataset comprises a plurality of subsets of data points having a plurality of classifications, wherein each subset of data points has a respective classification, and wherein the plurality of subsets of data points comprises the first plurality of data points having the first classification and the second plurality of data points having the second classification, the method further comprising:
determining an amount of orthogonality between each subset of data points having a classification; and
determining that the first plurality of data points having the first classification and the second plurality of data points having the second classification have a highest amount of orthogonality of the plurality of subsets of data points having the plurality of classifications; and
wherein performing the class rectification operation comprises:
performing the class rectification operation on the first plurality of data points having the first classification and the second plurality of data points having the second classification based on determining that the first plurality of data points having the first classification and the second plurality of data points having the second classification have the highest amount of orthogonality.

6. The computer-implemented method of claim 5, further comprising:
determining that a third plurality of data points having a third classification and a fourth plurality of data points having a fourth classification have a second highest amount of orthogonality of the plurality of subsets of data points having the plurality of classifications; and
performing the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

7. The computer-implemented method of claim 6, further comprising:
generating a third normalized class mean vector of the third plurality of data points having the third classification; and
generating a fourth normalized class mean vector of the fourth plurality of data points having the fourth classification;
wherein performing the class rectification operation on the third plurality of data points having the third classification and the fourth plurality of data points having the fourth classification comprises:
determining a second orthogonal space between the third normalized class mean vector and the fourth normalized class mean vector;
rotating each data point of the plurality of data points into the second orthogonal space to provide second rotated data points; and
projecting the second rotated data points into the original embedding space of the dataset to provide second original embedding space projections of the dataset; and
wherein generating the embeddings of the dataset comprises:
generating the embeddings of the dataset based on the second original embedding space projections of the dataset.

8. A system, comprising:
at least one processor configured to:
receive a dataset comprising a plurality of data points including a first plurality of data points having a first classification and a second plurality of data points having a second classification;
generate a first normalized class mean vector of the first plurality of data points having the first classification;
generate a second normalized class mean vector of the second plurality of data points having the second classification;
perform a class rectification operation on the first plurality of data points having the first classification and the second plurality of data points having the second classification, wherein, when performing the class rectification operation, the at least one processor is configured to:
determine an orthogonal space between the first normalized class mean vector and the second normalized class mean vector;
rotate each data point of the first plurality of data points and the second plurality of data points into the orthogonal space to provide rotated data points; and
project the rotated data points into an original embedding space of the dataset to provide original embedding space projections of the dataset; and
generate embeddings of the dataset based on the original embedding space projections of the dataset.

9. The system of claim 8, wherein, when determining the orthogonal space between the first normalized class mean vector and the second normalized class mean vector, the at least one processor is configured to:
find a portion of the second normalized class mean vector that is orthogonal to the first normalized class mean vector; and
define a projection function to provide the orthogonal space based on the first normalized class mean vector and the portion of the second normalized class mean vector that is orthogonal to the first normalized class mean vector.

10. The system of claim 9, wherein, when finding the portion of the second normalized class mean vector that is orthogonal to the first normalized class mean vector, the at least one processor is configured to:
determine an inner product of the first normalized class mean vector and the second normalized class mean vector;
multiply the inner product by the first normalized class mean vector to provide a first vector product; and
subtract the first vector product from the second normalized class mean vector to provide the portion of the second normalized class mean vector that is orthogonal to the first normalized class mean vector.

11. The system of claim 9, wherein, when rotating each data point into the orthogonal space, the at least one processor is configured to:
rotate each data point based on the projection function to provide the rotated data points.

12. The system of claim 8, wherein the dataset comprises a plurality of subsets of data points having a plurality of classifications, wherein each subset of data points has a respective classification, and wherein the plurality of subsets of data points comprises the first plurality of data points having the first classification and the second plurality of data points having the second classification, wherein the at least one processor is further configured to:
determine an amount of orthogonality between each subset of data points having a classification; and
determine that the first plurality of data points having the first classification and the second plurality of data points having the second classification have a highest amount of orthogonality of the plurality of subsets of data points having the plurality of classifications; and
wherein, when performing the class rectification operation, the at least one processor is configured to:
perform the class rectification operation on the first plurality of data points having the first classification and the second plurality of data points having the second classification based on determining that the first plurality of data points having the first classification and the second plurality of data points having the second classification have the highest amount of orthogonality.

13. The system of claim 12, wherein the at least one processor is further configured to:
determine that a third plurality of data points having a third classification and a fourth plurality of data points having a fourth classification have a second highest amount of orthogonality of the plurality of subsets of data points having the plurality of classifications; and
perform the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

14. The system of claim 13, wherein the at least one processor is further configured to:
generate a third normalized class mean vector of the third plurality of data points having the third classification; and
generate a fourth normalized class mean vector of the fourth plurality of data points having the fourth classification;
wherein, when performing the class rectification operation on the third plurality of data points having the third classification and the fourth plurality of data points having the fourth classification, the at least one processor is configured to:
determine a second orthogonal space between the third normalized class mean vector and the fourth normalized class mean vector;
rotate each data point of the plurality of data points into the second orthogonal space to provide second rotated data points; and
project the second rotated data points into the original embedding space of the dataset to provide second original embedding space projections of the dataset; and
wherein, when generating the embeddings of the dataset, the at least one processor is configured to:
generate the embeddings of the dataset based on the second original embedding space projections of the dataset.

15. A computer program product comprising at least one non-transitory computer-readable medium including program instructions that, when executed by at least one processor, cause the at least one processor to:
receive a dataset comprising a plurality of data points including a first plurality of data points having a first classification and a second plurality of data points having a second classification;
generate a first normalized class mean vector of the first plurality of data points having the first classification;
generate a second normalized class mean vector of the second plurality of data points having the second classification;
perform a class rectification operation on the first plurality of data points having the first classification and the second plurality of data points having the second classification, wherein, the program instructions that cause the at least one processor to perform the class rectification operation, the at least one processor is configured to:
determine an orthogonal space between the first normalized class mean vector and the second normalized class mean vector;
rotate each data point of the first plurality of data points and the second plurality of data points into the orthogonal space to provide rotated data points; and
project the rotated data points into an original embedding space of the dataset to provide original embedding space projections of the dataset; and
generate embeddings of the dataset based on the original embedding space projections of the dataset.

16. The computer program product of claim 15, wherein, the program instructions that cause the at least one processor to determine the orthogonal space between the first normalized class mean vector and the second normalized class mean vector, cause the at least one processor to:
find a portion of the second normalized class mean vector that is orthogonal to the first normalized class mean vector; and
define a projection function to provide the orthogonal space based on the first normalized class mean vector and the portion of the second normalized class mean vector that is orthogonal to the first normalized class mean vector.

17. The computer program product of claim 16, wherein, the program instructions that cause the at least one processor to find the portion of the second normalized class mean vector that is orthogonal to the first normalized class mean vector, cause the at least one processor to:
determine an inner product of the first normalized class mean vector and the second normalized class mean vector;
multiply the inner product by the first normalized class mean vector to provide a first vector product; and
subtract the first vector product from the second normalized class mean vector to provide the portion of the second normalized class mean vector that is orthogonal to the first normalized class mean vector.

18. The computer program product of claim 15, wherein the dataset comprises a plurality of subsets of data points having a plurality of classifications, wherein each subset of data points has a respective classification, and wherein the plurality of subsets of data points comprises the first plurality of data points having the first classification and the second plurality of data points having the second classification, wherein the program instructions further cause the at least one processor to:
determine an amount of orthogonality between each subset of data points having a classification; and
determine that the first plurality of data points having the first classification and the second plurality of data points having the second classification have a highest amount of orthogonality of the plurality of subsets of data points having the plurality of classifications; and
wherein, the program instructions that cause the at least one processor to perform the class rectification operation, cause the at least one processor to:
perform the class rectification operation on the first plurality of data points having the first classification and the second plurality of data points having the second classification based on determining that the first plurality of data points having the first classification and the second plurality of data points having the second classification have the highest amount of orthogonality.

19. The computer program product of claim 18, wherein the program instructions further cause the at least one processor to:
determine that a third plurality of data points having a third classification and a fourth plurality of data points having a fourth classification have a second highest amount of orthogonality of the plurality of subsets of data points having the plurality of classifications; and
perform the class rectification operation on the third plurality of data points having the third classification and the fourth plurality of data points having the fourth classification based on determining that the third plurality of data points having the third classification and the fourth plurality of data points having the fourth classification have the second highest amount of orthogonality.

20. The computer program product of claim 19, wherein the program instructions further cause the at least one processor to:
generate a third normalized class mean vector of the third plurality of data points having the third classification; and
generate a fourth normalized class mean vector of the fourth plurality of data points having the fourth classification;
wherein, the program instructions that cause the at least one processor to perform the class rectification operation on the third plurality of data points having the third classification and the fourth plurality of data points having the fourth classification, cause the at least one processor to:
determine a second orthogonal space between the third normalized class mean vector and the fourth normalized class mean vector;
rotate each data point of the plurality of data points into the second orthogonal space to provide second rotated data points; and
project the second rotated data points into the original embedding space of the dataset to provide second original embedding space projections of the dataset; and
wherein, the program instructions that cause the at least one processor to generate the embeddings of the dataset, cause the at least one processor to:
generate the embeddings of the dataset based on the second original embedding space projections of the dataset.
